(19) United States
(12) Patent Application Publication
(10) Pub. No.: US 2025/0048481 A1
(43) Pub. Date: Feb. 6, 2025

(54) SUPER-UE RADIO RESOURCE CONTROL (RRC) CONNECTION

(71) Applicant: Apple Inc., Cupertino, CA (US)

(72) Inventors: Fangli XU, Beijing (CN); Alexander SIROTKIN, Herzliya (IL); Haijing HU, Los Gatos, CA (US); Naveen Kumar R. Palle VENKATA, San Diego, CA (US); Pavan NUGGEHALLI, San Carlos, CA (US); Ralf ROSSBACH, Munich (DE); Sarma V. VANGALA, Campbell, CA (US); Sethuraman GURUMOORTHY, San Ramon, CA (US); Yuqin CHEN, Beijing (CN); Zhibin WU, Los Altos, CA (US)

(21) Appl. No.: 18/710,159

(22) PCT Filed: Nov. 19, 2021
(86) PCT No.: PCT/CN2021/131866

§ 371 Date: May 14, 2024

(51) Int. Cl. H04W 76/27; H04W 74/0833

(52) U.S. Cl. CPC H04W 76/27; H04W 74/0833

(57) ABSTRACT

One embodiment described herein takes the form of a user equipment (UE), such as a phone. The UE includes a transceiver and a processor. The processor is configured to establish a first radio resource control (RRC) connection with a base station via the transceiver. The processor is configured to associate with a secondary UE for collaboration of transmission of a data payload of one of the UE or the secondary UE to the base station, and transmit a first portion of the data payload to the base station via the transceiver.

### CROSS-REFERENCE TO RELATED APPLICATION

This application is a 35 U.S.C. § 371 application of PCT/CN2021/131866, filed on Nov. 19, 2021, and entitled “Super-UE Radio Resource Control (RRC) Connection,” which is incorporated herein by reference as if fully disclosed herein.

### TECHNICAL FIELD

Embodiments described herein generally relate to wireless communication systems, including methods and apparatus for a Super-UE radio resource control (RRC) connection.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example radio access network of a number of cells.

FIG. 2 depicts a virtual cluster of wireless communication devices, according to embodiments disclosed herein.

FIG. 3 depicts an example super-UE radio resource control (RRC) connection, according to embodiments disclosed herein.

FIG. 4 depicts an example of an anchor UE based super-UE RRC connection, according to embodiments disclosed herein.

FIG. 5A depicts an example message flow for establishing a super-UE RRC connection via an Access Stratum (AS) capability request and AS capability report message, according to embodiments disclosed herein.

FIG. 5B depicts an example message flow for establishing a super-UE RRC connection via an Access Stratum (AS) capability request and AS capability report message, and obtaining UE capability for a secondary UE from a core network, an anchor-UE, or the secondary-UE, according to embodiments disclosed herein.

FIG. 6 depicts another example message flow for establishing a super-UE RRC connection via a UE assistance information (UAI) message, according to embodiments disclosed herein.

FIG. 7 depicts another example message flow for establishing a super-UE RRC connection using an RRC setup procedure, according to embodiments disclosed herein.

FIG. 8 depicts an example message flow for establishing a super-UE RRC connection using a non-access stratum (NAS) signaling and reconfiguring the super-UE RRC connection, according to embodiments disclosed herein.

FIG. 9 depicts an example message flow for establishing a super-UE having a number of RRC connections via an Access Stratum (AS) capability request and AS capability response message, according to embodiments disclosed herein.

FIG. 10 depicts an example message flow for UE reporting support of a super-UE connection mode to a network via a UE assistance information (UAI) message, according to embodiments disclosed herein.

FIG. 11 depicts an example message flow for establishing a super-UE having a number of RRC connections via a RRCReconfiguration procedure, according to embodiments disclosed herein.

FIG. 12A depicts an example message flow for establishing a super-UE in which a number of RRC connections are added to the super-UE using an initial access procedure, according to embodiments disclosed herein.

FIG. 12B depicts an example message flow for establishing a super-UE in which a number of RRC connections having different capabilities are added to the super-UE using an initial access procedure in a second UE link, according to embodiments disclosed herein.

FIG. 13 depicts an example architecture of a wireless communication system, according to embodiments disclosed herein.

FIG. 14 depicts a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

Embodiments described herein describe a wireless connection device (user equipment (UE)) and message flow between one or more UEs with a base station (e.g., an eNodeB, an eNB, a gNB) to establish a super-UE radio resource control (RRC) connection. A UE, upon powering on, establishes a RRC connection with the base station to access network resources to communicate with a core network for various services and/or features. Using the RRC connection, the UE exchanges signaling information with the base station for establishing, modifying, and releasing of a signaling radio bearer (SRB) path and a data radio bearer (DRB) path. The RRC connection is also used for exchange of paging information, handover information, and measurement reporting.

As described herein, a UE at an edge of a cell coverage area may not transmit data in an uplink direction (e.g., from the UE to the base station) at a higher transmission power to avoid interference with other neighboring UEs. Accordingly, available bandwidth for data transmission may be limited for data transmission between the UE and the base station. A UE can, however, collaborate with one or more other UEs for data transmission, and thereby the throughput of the data transmission can be improved. The UE in collaboration with the one or more other UEs for data transmission at a higher throughput thus creates a virtual cluster of UEs. The virtual cluster of UEs through UE aggregation may be referenced as a super-UE in the present disclosure. As described in detail below, aggregation of two or more UEs may allow the two or more UEs to achieve higher data throughput. The higher data throughput, e.g., transmission of data in an uplink direction, from a UE to a base station, may be achieved without the UE needing to transmit data at an increased transmit power. By way of a non-limiting example, data payload to send to the base station from the UE may be split in two or more portions, which may be send to the base station using the UE and/or the one or more other UEs collaborated with the UE to form the super-UE. For example, a first portion of the data payload may be sent to the base station using a link of the UE with the base station, and a second portion of the data that is different from the first portion may be send to the base station using a link of another UE of the super-UE. Accordingly, the embodiments described in the present disclosure may improve user experience.

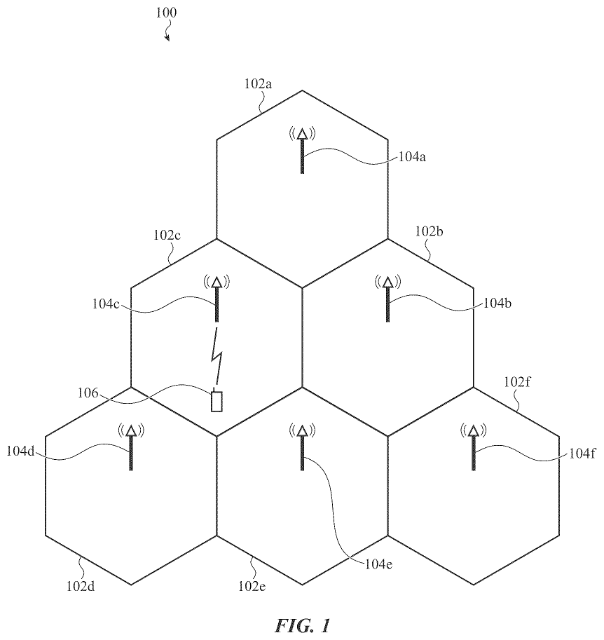

FIG. 1 depicts an example radio access network of a number of cells. A radio access network 100 may include a number of cells 102a, 102b, 102c, 102d, 102e, and 102f. Each cell of the number of cells may provide radio access coverage through a base station. For example, a base station 104a in the cell 102a may provide radio access to one or more UEs in a cell coverage area of the cell 102a. Similarly, base stations 104b, 104c, 104d, 104c, and 104f may provide radio access to one or more UEs in a cell coverage area of cells 102b, 102c, 102d, 102e, and 102f, respectively.

A UE 106 in the cell 102c when more proximate to the base station 104c may transmit data in the uplink direction at a higher throughput. The UE 106 may not require a higher transmit power for transmission of the data in the uplink direction due to a good quality radio signal strength. But, as the UE 106 moves away from the base station 104c, near an edge of the cell 102c, a radio signal from the base station 104c may become weak due to fading and/or interference from radio signals from base stations in other neighboring cells. As a result of a weak radio signal from the base station serving the cell, the UE cannot transmit data at a higher transmit power without causing interference to other neighboring UEs.

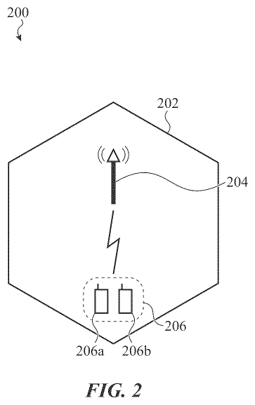

FIG. 2 depicts a virtual cluster of wireless communication devices, according to embodiments disclosed herein. As stated above, a RRC connection is used for establishing, modifying, and releasing of signaling radio bearer (SRB) and data radio bearer (DRB). Accordingly, each UE receives, from a base station to which the UE is attached, configuration information for controlling of the connection and data transmission over a RRC connection established between the UE and the base station. The connection is controlled based on control signaling information in the SRB. The data is transmitted in the DRB. Thus, each UE receives individual configuration information for managing control connection and data transmission with the base station over a RRC connection between the UE and the base station.

In a radio access network 200 of FIG. 2, a base station 204 provides radio access to UEs 206a and 206b within a coverage area of a cell 202. The UEs 206a and 206b may both be near an edge of the cell 202. The UEs at the edge of the cell require higher transmit power in comparison with the transmit power required when the UEs are near the center of the cell or more proximate to a base station serving the cell. The transmit power at which the UE may transmit data may be limited for various reasons, e.g., for avoiding interference with the other neighboring UEs. However, as described herein, the UEs 206a and 206b may be aggregated together to form a virtual cluster 206, or a super-UE 206. Through UE aggregation of the UEs 206a and 206b, a super-UE 206 may receive control signaling information for each member-UE of the virtual cluster 206 from the base station 204 at one of the member-UEs over a RRC connection. The virtual cluster 206 here is shown to include only two UEs 206a and 206b, but there may be more than two UEs in a virtual cluster. In some cases, a number of UEs in a virtual cluster may be limited to a specific number of UEs, e.g., 10 UEs. The maximum number of UEs in the virtual cluster may be limited either by configuration at a base station and/or a core network.

In other words, in a legacy radio access network, where two RRC connections may be present for two UEs, when the two UEs are aggregated to form a virtual cluster of UEs or a super-UE, only one RRC connection is needed in some embodiments. The RRC connection for the super-UE may be between the base station and any one of the member-UEs of the super-UE. The member UE of the super-UE having a RRC connection with the base station may be referenced as an anchor UE, while other UEs may be referenced as secondary-UEs. Accordingly, the anchor-UE may maintain an access stratum (AS) connection for all the UEs of the super-UE in the anchor-UE based super-UE connection configuration. The secondary-UEs may only be responsible for a layer1 (L1) or layer2 (L2) data transmission, the secondary-UEs may not be responsible for any AS and/or Non-Access Stratum (NAS) signaling with the base station in the anchor-UE based super-UE configuration.

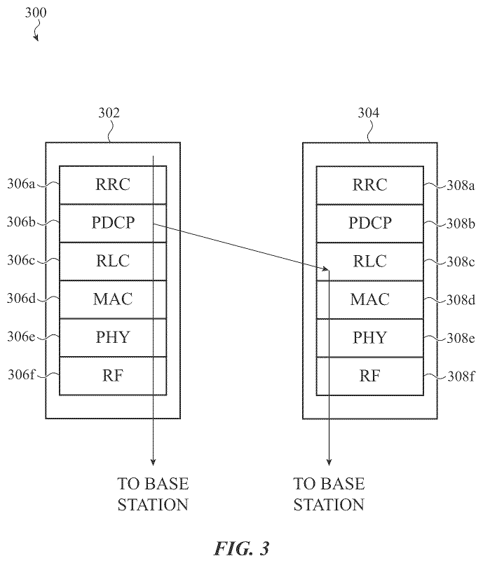

FIG. 3 depicts an example protocol stack for a super-UE, according to embodiments disclosed herein. A UE1 302 and a UE2 304 may be aggregated to form an anchor-UE based super-UE 300. Each member UE 302 and 304 of the super-UE 300 may include a protocol stack. A protocol stack 306 of the UE1 302 may include a layer1 as a PHY layer 306e, a layer2 as a MAC layer 306d, a layer3 as a RLC layer 306c, a layer4 as a PDCP layer 306b, and a layer5 as a RRC layer 306a. Similarly, a protocol stack 308 of the UE2 304 may include a layer1 as a PHY layer 308e, a layer2 as a MAC layer 308d, a layer3 as a RLC layer 308c, a layer4 as a PDCP layer 308b, and a layer5 as a RRC layer 308a.

In a legacy radio access network, each of the UE1 302 and the UE2 304 may have a RRC connection with the base station (e.g., the base station 204) over a radio frequency (RF) connection 306f and 308f, respectively, using each layer of the protocol stacks 306 and 308 described above. In accordance with some embodiments, in the anchor-UE based super-UE connection, a RRC connection may be established with the base station (e.g., the base station 204) using each layer of the protocol stack 306 or the protocol stack 308, but not both. Accordingly, the UE1 302 having a RRC connection established with the base station may be the anchor-UE of the super-UE 300 and the UE2 304 may be the secondary-UE.

In the super-UE, the secondary-UEs are responsible for L1/L2 data transmission, as stated above. Accordingly, a connection or channel may be established between the UE1 302 and the UE2 304 for transmission of data from any of the UE1 302 and/or UE2 304 to the base station. The connection or channel may be established between the UE1 302 and the UE2 304 such that the PDCP layer of the anchor-UE may have connection endpoints with an RLC layer of the anchor-UE and the secondary-UEs.

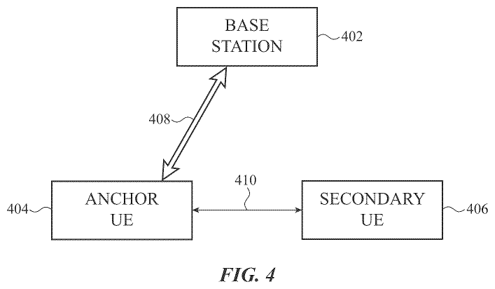

FIG. 4 depicts an example of an anchor UE based super-UE RRC connection, according to embodiments disclosed herein. As shown in FIG. 4, an anchor-UE 404 and a secondary-UE 406 are aggregated to form a super-UE, in which the anchor-UE 404 has a RRC connection 408 with a base station 402 for the anchor-UE 404 and the secondary-UE 406. As described above, a connection or a channel 410 between the anchor-UE 404 and the secondary-UE 406 enables L1/L2 data transmission for transmission of data from any of the UE1 302 and/or UE2 304 to the base station 402. In some cases, an anchor-UE may be a UE which needs to transmit data in an uplink direction at a higher throughput without using a higher transmit power. In some cases, an anchor-UE may be a UE which may help transmit data of one or more secondary-UEs to the base station in a super-UE connection mode.

In some embodiments, aggregation of two or more UEs to form a super-UE may be achieved during an initial access procedure. During the initial access procedure, messages are exchanged between a UE and a base station for the UE to acquire uplink synchronization and a specific ID for the radio access communication. Accordingly, during the initial access procedure, a UE may indicate its capability to form a super-UE by aggregating with one or more other UEs to form a super-UE. The initial access procedure may be performed using an RRCSetupRequest or a random access channel (RACH) procedure.

In some embodiments, a UE may report super-UE specific capability in a capability report or in a super-UE suggestion information message. The capability report or the super-UE suggestion information message may indicate support for a super-UE connection mode, a maximum number of UEs that can join in the super-UE connection mode, L1/L2 capability of each UE link of the super-UE, and a UE identifier (UE ID) for a link for each secondary-UE.

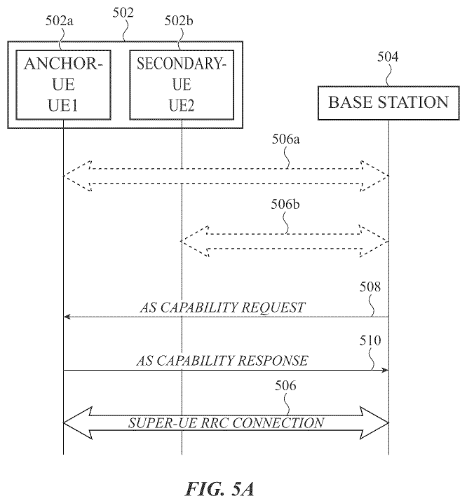

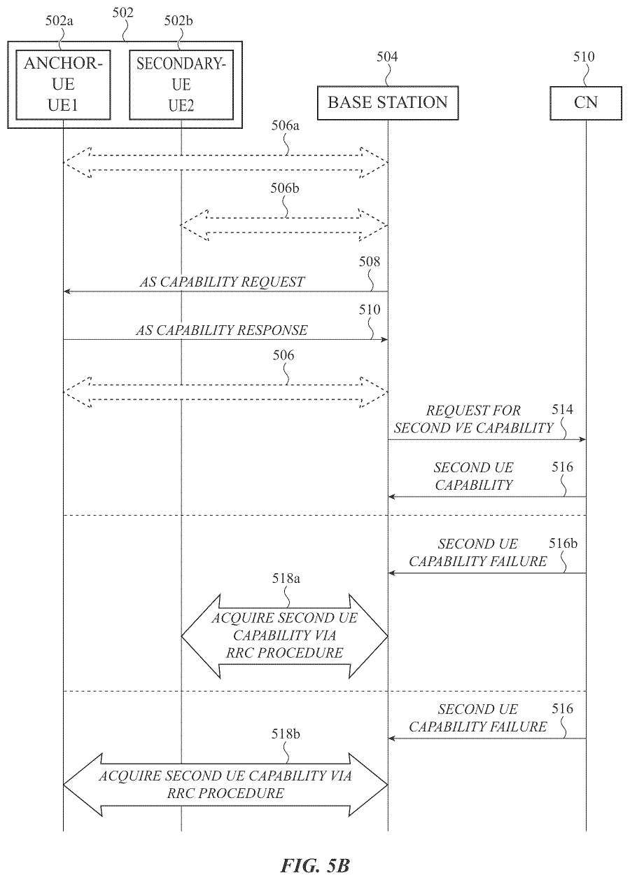

FIG. 5A depicts an example message flow for establishing a super-UE RRC connection via an Access Stratum (AS) capability request and AS capability report message, according to embodiments disclosed herein. The AS capability request and the AS capability report message may be similar to other capability request and report messages exchanged between a UE and a base station. As shown in FIGS. 5A-5B, a UE1 502a and a UE2 502b may form a super-UE 502 after exchange of AS capability Request and AS capability report messages with a base station 504. The UEs UE1 502a and UE2 502b may have a RRC connection 506a and 506b, respectively, with the base station 504. Using RRC signaling over the established RRC connection 506a, the base station 504 may request the UE1 502a to send AS capability information for the UE1 502a and/or the UE2 502b in AS capability request message 508. The AS capability request message 508 may request information specific to the super-UE connection mode.

The UE1 502a may specify in an AS capability report message 510 information including a UE's capability to form a super-UE. The UE may specify, in the AS capability report message 510, whether the UE can join the super-UE connection mode as an anchor-UE and/or a secondary-UE. A maximum number of UE links that can be supported for a super-UE may also be indicated in the AS capability report message 510. In other words, the UE may specify a maximum number of connection endpoints between the PDCP layer and the RLC layer of its protocol stack. The UE may also specify a UE link ID for each UE link and/or capability for the secondary-UE. The capability for the secondary-UE may include, for example, but not limited to, information of a multiple-in and multiple-out (MIMO) layer, information of component carriers (CC) for carrier aggregation, and so on. Upon receiving the AS capability report message 510, the base station 504 may instruct the UE1 502a to form the super-UE 502. The RRC connection 506a then may become a super-UE RRC connection 506.

In some embodiments, an anchor-UE may not have information about one or more secondary-UEs that may be aggregated to form a super-UE connection. As a result, an AS capability report message 510 may only indicate UE capabilities of the anchor-UE. The base station 504, upon receiving the AS capability report message 510 from the anchor-UE UE1 502a with UE capability information of the UE1 502a only, may query a core network 512 for the secondary-UE UE2 502b's UE capability information. The core network 512 may send a message 516a indicating the secondary-UE UE2 502b's UE capability information. The base station 504 may then send super-UE configuration information to the anchor-UE to form the super-UE 502.

In some embodiments, when the core network 512 does not return the secondary-UE UE2 502b's UE capability information in response to 514, a failure message 516b may be received at the base station 504 from the core network 512. The base station may then perform a procedure 518a with the secondary-UE UE2 502b to acquire UE capability information of the secondary-UE UE2 502b. The procedure 518a may be performed using the RRC connection 506b of the UE2 502b with the base station 504. Upon receiving UE capability information of the secondary-UE UE2 502b using the procedure 518a, the super-UE 502 may be formed with the UE1 502a as an anchor-UE.

In some embodiments, when the core network 512 does not return the secondary-UE UE2 502b's UE capability information in response to 514, a failure message 516c may be received at the base station 504 from the core network 512. The base station may then perform a procedure 518b with the anchor-UE UE1 502a to acquire UE capability information of the secondary-UE UE2 502b. The procedure 518b may be performed using the RRC connection 506a of the UE1 502a with the base station 504. Upon receiving UE capability information of the secondary-UE UE2 502b using the procedure 518b, the super-UE 502 may be formed with the UE1 502a as an anchor-UE. In some cases, the failure messages 516b and/or 516c may also indicate a failure reason. In some cases, the failure messages 516b and/or 516c may also indicate whether the base station 504 perform the procedure 518b or 518c. In some cases, the failure messages 516b and/or 516c may also indicate an order in which the procedure 518b and/or 518c may be performed to acquire UE capability information of the secondary UE.

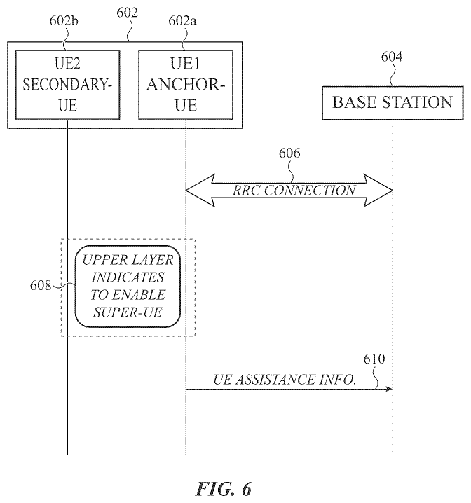

In some embodiments, aggregation of two or more UEs to form a super-UE may be achieved via a UE information report to a network, for example, in a UE assistance information (UAI) message. FIG. 6 depicts another example message flow for establishing a super-UE RRC connection via a UE assistance information (UAI) message, according to embodiments disclosed herein. As shown in FIG. 6, a UE1 602a and/or a UE2 602b may have a RRC connection with a base station 604. In FIG. 6, a RRC connection 606 between the UE1 602a and the base station 604 is shown. An upper layer of a protocol stack of the UE1 602a and/or the UE2 602b, e.g., a non-access stratum (NAS) layer, may initiate the super-UE connection mode enabling 608, in response to a measurement report of radio signal connection meeting a specific criterion. The UE1 602a and/or the UE2 602b may send a UAI message 610 to the base station 604 to indicate to the base station 604 preference to enable or disable the super-UE connection mode and information for each UE-link of the member-UEs of a super-UE 602. In FIG. 6, the UAI message 610 is shown to be sent by the UE1 602a to the base station 604, but a UAI message may also be sent from the UE2 602b to the base station to form a super-UE 602. In some cases, the UAI message may be sent from an anchor-UE only.

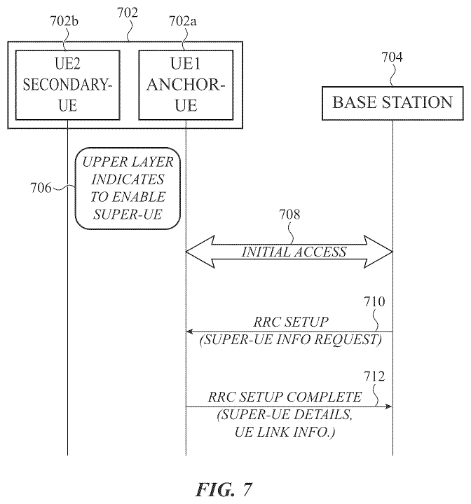

In some embodiments, a RRC response message, such as a RRCSetupComplete or a RRCReconfigComplete, may be used for aggregation of two or more UEs to form a super-UE. FIG. 7 depicts another example message flow for establishing a super-UE RRC connection using an RRC setup procedure, according to embodiments disclosed herein. As shown in FIG. 7, an upper layer of a protocol stack of the UE1 702a and/or the UE2 702b, e.g., a non-access stratum (NAS) layer, may initiate the super-UE connection mode enabling 706, in response to a measurement report of a radio signal connection meeting a specific criterion. The UE1 702a and/or the UE2 702b may perform an initial access procedure 708 with a base station 704. The UE1 702a and/or the UE2 702b may already have a RRC connection with the base station 704. The initial access procedure 708 may be a RACH procedure or an RRC connection setup procedure. Upon performing the RACH procedure 708, the UE1 702a and/or the UE2 702b may indicate a preference to enable the super-UE connection mode. The base station 704 may send a RRCSetup message 710 to the UE1 702a or the UE2 702b to request information about a super-UE 702, which includes the UE1 702a and the UE2 702b. The UE1 702a or the UE2 702b may send an RRCSetupComplete message 712 including information for each UE-link and their capabilities, and so on, for the super-UE 702.

In some embodiments, a base station may receive information from a core network regarding enabling and/or disabling of a super-UE connection mode and/or configuration information for each member-UE of the super-UE connection. The base station may provide a configuration for enabling and/or disabling of a super-UE connection mode and a configuration for each member-UE of the super-UE connection in RRC signaling.

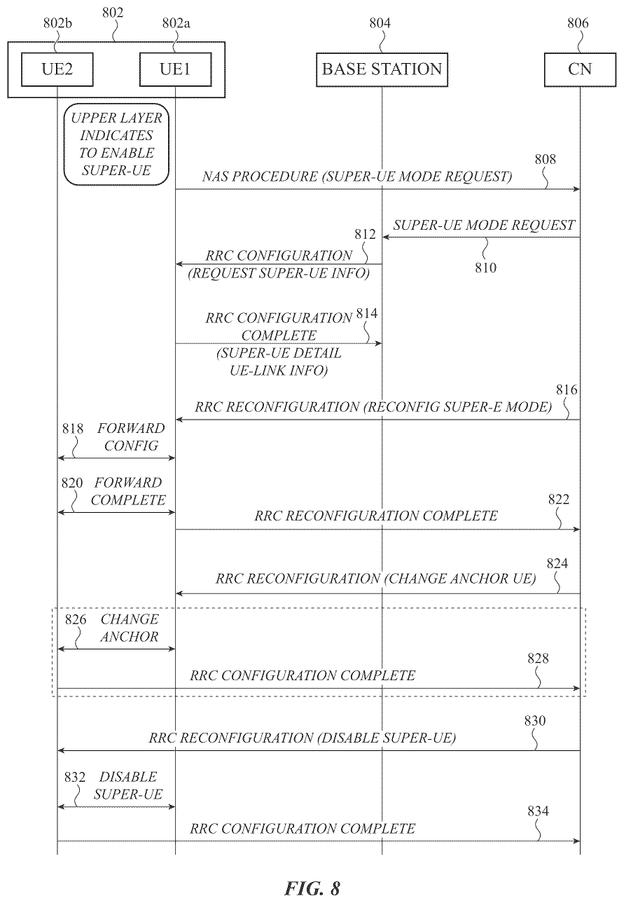

FIG. 8 depicts an example message flow for establishing a super-UE RRC connection using a non-access stratum (NAS) signaling and reconfiguring the super-UE RRC connection, according to embodiments disclosed herein. A UE1 802a and a UE2 802b may be connected with a base station 804. The UE1 802a and the UE2 802b may communicate with a core network 806 via the base station 804. An upper layer of a protocol stack of the UE1 802a and/or the UE2 802b, e.g., a non-access stratum (NAS) layer, may initiate the super-UE connection mode using a NAS procedure 808.

Using the NAS procedure 808, the UE1 802a and/or the UE2 802b may indicate to the core network that a super-UE connection mode be enabled. Accordingly, the core network 806 may send a message to the base station, for example, a super-UE connection mode request 810, to request additional information for the super-UE connection mode. The base station may then send a RRCReconfiguration message 812 to request information related to a super-UE 802, which includes the UE1 802a and the UE2 802b. The UE1 802a or the UE2 802b may send a RRCReconfigurationComplete message 814 to the base station. The RRCReconfigurationComplete message 814 may include information for the super-UE, such as information for each UE-link, the number of UEs, and so on, as mentioned above.

Once a super-UE connection mode is enabled, data may be transmitted in an uplink direction over a data link from an anchor-UE and a data link from one or more secondary-UEs. As a result, data throughput may be increased for a UE at an edge of a cell without transmitting data at a higher transmit power. In some cases, an anchor-UE may be updated after a super-UE connection mode is enabled. For example, a super-UE connection mode may be enabled with the UE1 802a as an anchor-UE and the UE2 802b as a secondary-UE. The anchor-UE may be changed from the UE1 802a to the UE2 802b.

As shown in FIG. 8, reconfiguration of the super-UE 802, for example, a change in the number of UE links, and so on, may be initiated by the base station 804 using RRCReconfiguration message 816 to the current anchor-UE, for example, the UE2 802b. The UE2 802b may then forward a new or updated configuration 818 to one or more secondary-UEs. The one or more secondary-UEs may then send a message to the anchor-UE indicating completion of the configuration update in a forward complete message 820. The anchor-UE may then send RRCReconfigurationComplete message 822 to the base station 804.

As shown in FIG. 8, reconfiguration of the super-UE 802 may be related to a change in the anchor-UE. For example, a change in the anchor-UE may be initiated by the base station 804 using a RRCReconfiguration message 824 to a current anchor-UE, for example, the UE2 802b. The UE2 802b may then send a change anchor message 826 to one or more secondary-UEs. The current anchor-UE and the one or more secondary-UEs then update their configuration for the anchor-UE, for example, the UE1 802a. The new anchor-UE, the UE1 802a, may then send a RRCReconfigurationComplete message 828 to the base station 804.

A RRCReconfiguration message may also be used to disable the super-UE connection mode. As shown in FIG. 8, the base station may send a RRCReconfiguration message 830 to the anchor-UE, e.g., the UE1 802a, to disable the super-UE connection mode. The anchor-UE then sends a message, for example, disable super-UE 832, to the secondary-UEs. The anchor-UE 802a then sends a RRCReconfigurationComplete message 834 to the base station 804. As shown here, a RRCReconfiguration message may be used to enable and/or disable a super-UE connection mode.

In some embodiments, a super-UE connection mode may include more than one RRC connection. Accordingly, more than one UE may have a RRC connection with a base station. Each UE in the super-UE may then transmit data in an uplink direction using L1/L2 transmission capability of other UEs in the super-UE.

In some embodiments, by way of a non-limiting example, the RRCReconfiguration message may be used to establish a RRC connection with any member-UE of the super-UE, and release a RRC connection of any member-UE of the super-UE. For example, for a change in an anchor-UE of the super-UE, RRCReconfiguration message may be used to release a RRC connection of a current anchor-UE and establish a new RRC connection with another member-UE of the super-UE.

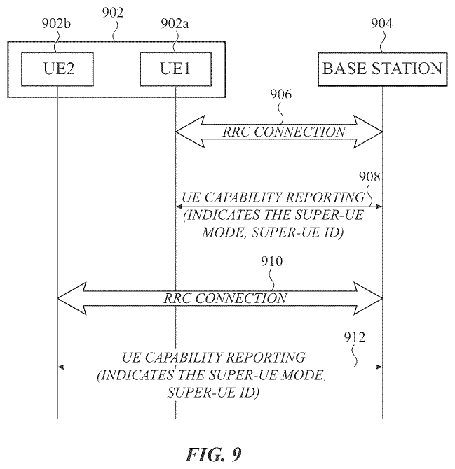

FIG. 9 depicts an example message flow for establishing a super-UE having a number of RRC connections, according to embodiments disclosed herein. As shown in FIG. 9, a UE1 902a and a UE2 902b each may have a RRC connection 906 and 910, respectively, with a base station 904 using an initial access procedure, e.g., a RACH procedure, and so on, as described herein. The base station 904 may then inquire each of the UEs, the UE1 902a and the UE2 902b, its capability using a UE capability reporting 908 and 912 with the UE1 902a and the UE2 902b, respectively. The UE capability reporting 908 and 912 each include an AS Capability Request message and an AS capability Report described above with reference to FIG. 5. Upon receiving the AS Capability Report message, the base station may instruct the UE1 902a and/or the UE2 902b to form a super-UE 902. However, in this case, a RRC connection of each of the UE1 902a and the UE2 902b may become a super-UE RRC connection. Thus, a super-UE 902 including the UE1 902a and the UE2 902b may have a super-UE RRC connection in redundant mode and/or a load balancing mode.

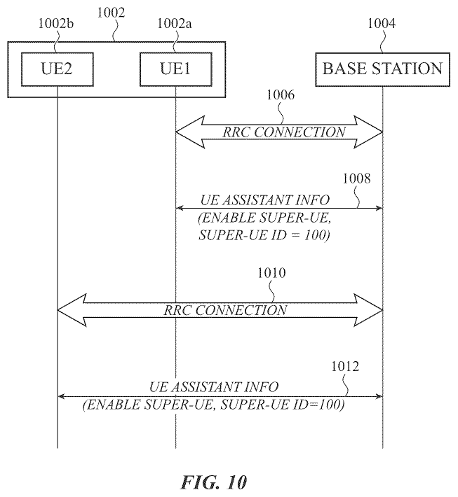

FIG. 10 depicts an example message flow for establishing a super-UE having a number of RRC connections via a UE assistance information (UAI) message, according to embodiments disclosed herein. The message flow shown in FIG. 10 is similar to the message flow described using FIG. 6. A UE1 1002a and a UE2 1002b may have a RRC connection 1006 and 1010, respectively, with a base station 1004. The UE1 1002a and the UE2 1002b may form a super-UE 1002 using a UEAssistanceInfo procedure 1008 and 1012, respectively, with the base station 1004. The UEAssistanceInfo procedure 1008 and 1012 may include sending a message from a UE to a base station indicating a UE's preference to enable or disable the super-UE connection mode and information for each UE-link of the member-UEs of a super-UE 1002.

In some embodiments, a network may determine that two or more UEs can form a super-UE based on a super-UE ID assigned to each UE. Each UE configuration at a core network may include a super-UE ID. UEs that belong to a single user and/or a single organization each may be assigned the same super-UE ID. Accordingly, when more than one UE with the same super-UE ID may be in close proximity with each other to form a super-UE, the core network and/or a base station serving the UEs may request the UEs to form a super-UE.

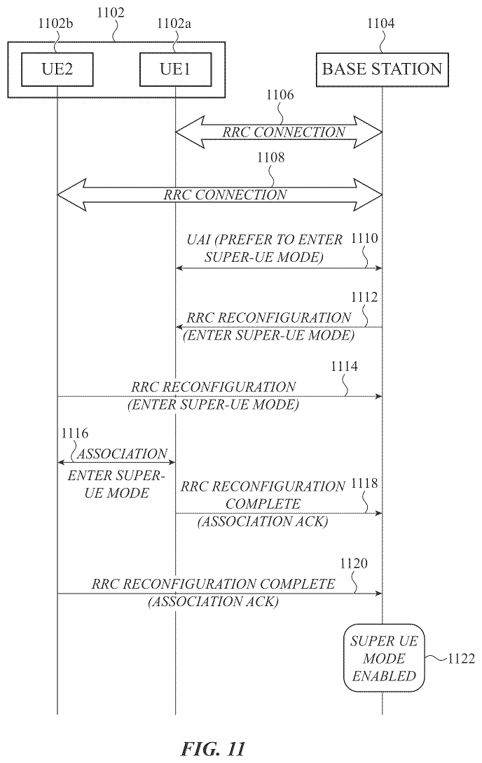

FIG. 11 depicts an example message flow for establishing a super-UE having a number of RRC connections via a RRCReconfiguration procedure, according to embodiments disclosed herein. As shown in FIG. 11, a UE1 1102a and a UE2 1102b each has a RRC connection 1106 and 1108, respectively, with a base station 1104. The UE1 1102a and/or the UE2 1102b may indicate their preference to enable a super-UE connection mode using the UAI procedure 1110, as described above with reference to FIG. 10. The base station 1104 may then send a RRCReconfiguration message 1112 and 1114 to the UE1 1102a and the UE2 1102b, respectively. The UE1 1102a and the UE2 1102b may associate 1116 to form a super-UE 1102 in accordance with configuration information received from the base station 1104 in the RRCReconfiguration messages 1112 and 1114. Each of the UE1 1102a and the UE2 1102b may then send a RRCReconfigurationComplete message 1120 and 1118, respectively, to the base station 1104 to acknowledge completion of association between the member-UEs of the super-UE 1102. In other words, a super-UE connection mode is enabled 1122 which includes as its member-UEs the UE1 1102a and the UE2 1102b.

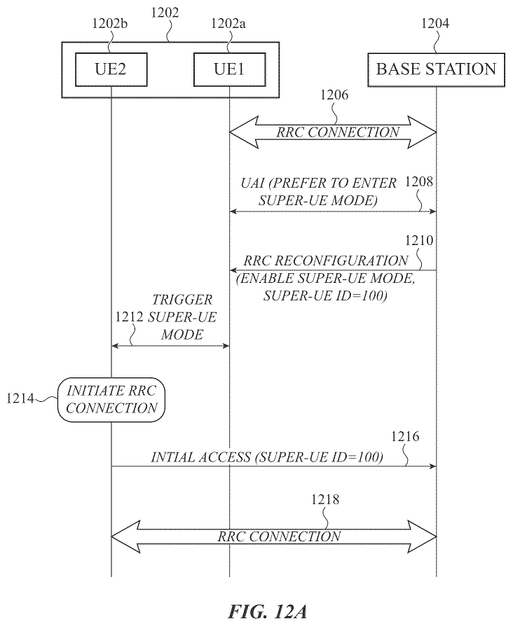

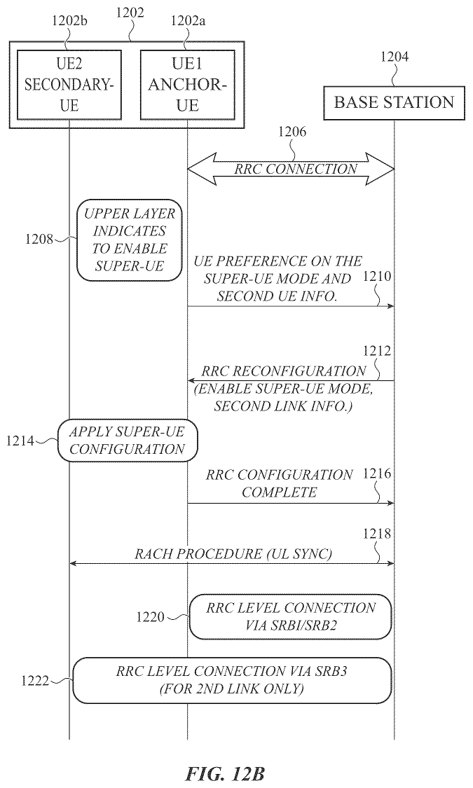

Various embodiments are described above in which a super-UE connection may have a single RRC connection between an anchor-UE and a base station, or a super-UE connection may have a number of RRC connections before the UEs may enter into a super-UE connection mode. FIG. 12A depicts an example message flow for establishing a super-UE in which a number of RRC connections are added to the super-UE using an initial access procedure, according to embodiments disclosed herein. As shown in FIG. 12, a UE1 1202a may have a RRCconnection 1206 with a base station 1204. The UE1 1202a may perform a UAI procedure 1208 with the base station as described above to form a super-UE connection 1202 with a UE1 1202a. The UE2 1202b may be an anchor-UE for the super-UE 1202. Accordingly, the base station 1204 may send a RRCReconfiguration message 1210 to the anchor-UE 1202b. Upon receiving the RRCReconfiguration message 1210, the super-UE 1202 may be formed by exchanging 1212 the received super-UE configuration messages with the secondary-UEs, e.g., 1202a.

In some cases, the secondary-UE 1202a may initiate 1214 a RRC connection 1218 between the UE2 1202b and the base station 1204 using an Initial Access procedure 1216. The UE1 1202a may initiate the RRC connection 1218 based on the quality of a link between the UE1 1202a and the UE2 1202b. Accordingly, a RRC connection redundancy may be added for the super-UE 1202.

FIG. 12B depicts an example message flow for establishing a super-UE in which a number of RRC connections having different capabilities are added to the super-UE using an initial access procedure, according to embodiments disclosed herein. As shown in FIG. 12, the UE1 1202a and the UE2 1202b each may have a RRC connection with the base station 1204. In FIG. 12B, a RRCconnection 1206 between the UE1 1202a and the base station 1204 is shown. When an upper layer (e.g., a NAS layer) of the UE1 1202a and/or the UE2 1202b indicates to enable a super-UE connection mode 1208, the UE1 1202a, for example, may send UE preference information 1210 regarding a super-UE connection 1202. The UE preference information 1210 may also include UE capability information of one or more secondary-UEs, e.g., the UE2 1202b. The base station 1204 may instruct the UE1 1202a to form the super-UE 1202 using a RRCReconfiguration message 1212 and a RRCReconfigurationComplete 1216 message. The UE1 1202a would exchange 1214 the received super-UE configuration with the UE2 1202b.

As shown in FIG. 12B, the UE2 1202b may initiate a RACH procedure 1218 once the super-UE 1202 is established. The RACH procedure 1218 may be initiated to update a RRC connection for each UE to have a different capability. For example, a RRC connection of the UE1 1202a may be used for the exchange of configuration, reconfiguration, and so on, 1220 for the super-UE 1202, and a RRC connection of the UE2 1202b may be used only for configuration of a UE link of the UE2 1202b 1222, but not for the super-UE 1202.

Embodiments contemplated herein include an apparatus having a means to perform one or more elements of the message flows of FIGS. 5A, 5B, 6-11, 12A, and 12B. In the context of message flows of FIGS. 5A, 5B, 6-11, 12A, and 12B, this apparatus may be, for example, an apparatus of a UE (such as a wireless device 1402 that is a UE, as described herein) or an apparatus of a base station (such as a network device 1420 that is a base station, as described herein).

Embodiments contemplated herein include one or more non-transitory computer-readable media storing instructions to cause an electronic device, upon execution of the instructions by one or more processors of the electronic device, to perform one or more elements of the message flows of FIGS. 5A, 5B, 6-11, 12A, and 12B. In the context of message flows of FIGS. 5A, 5B, 6-11, 12A, and 12B, this non-transitory computer-readable media may be, for example, a memory of a UE (such as a memory 1406 of a wireless device 1402 that is a UE, as described herein) or a memory of a base station (such as a memory 1424 of a network device 1420 that is a base station, as described herein).

Embodiments contemplated herein include an apparatus having logic, modules, or circuitry to perform one or more elements of the message flows of FIGS. 5A, 5B, 6-11, 12A, and 12B. In the context of message flows of FIGS. 5A, 5B, 6-11, 12A, and 12B, this apparatus may be, for example, logic, modules, or circuitry of a UE (such as a wireless device 1402 that is a UE, as described herein) or logic, modules, or circuitry of a base station (such as a network device 1420 that is a base station, as described herein).

Embodiments contemplated herein include an apparatus having one or more processors and one or more computer-readable media, using or storing instructions that, when executed by the one or more processors, cause the one or more processors to perform one or more elements of the message flows of FIGS. 5A, 5B, 6-11, 12A, and 12B. In the context of message flows of FIGS. 5A, 5B, 6-11, 12A, and 12B, this apparatus may be, for example, one or more processors or computer-readable media of a UE (such as a wireless device 1402 that is a UE, as described herein), or one or more processors or computer-readable media of a base station (such as a network device 1420 that is a base station, as described herein).

Embodiments contemplated herein include a signal as described in or related to one or more elements of the message flows of FIGS. 5A, 5B, 6-11, 12A, and 12B.

Embodiments contemplated herein include a computer program or computer program product having instructions, wherein execution of the program by a processor causes the processor to carry out one or more elements of the message flows of FIGS. 5A, 5B, 6-11, 12A, and 12B. In the context of message flows of FIGS. 5A, 5B, 6-11, 12A, and 12B, the processor may be a processor of a UE (such as a processor(s) 1404 of a wireless device 1402 that is a UE, as described herein), and the instructions may be, for example, located in the processor and/or on a memory of the UE (such as a memory 1406 of a wireless device 1402 that is a UE, as described herein); or the processor may be a processor of a base station (such as a processor(s) 1422 of a network device 1420 that is a base station, as described herein), and the instructions may be, for example, located in the processor and/or on a memory of the base station (such as a memory 1424 of a network device 1420 that is a base station, as described herein).

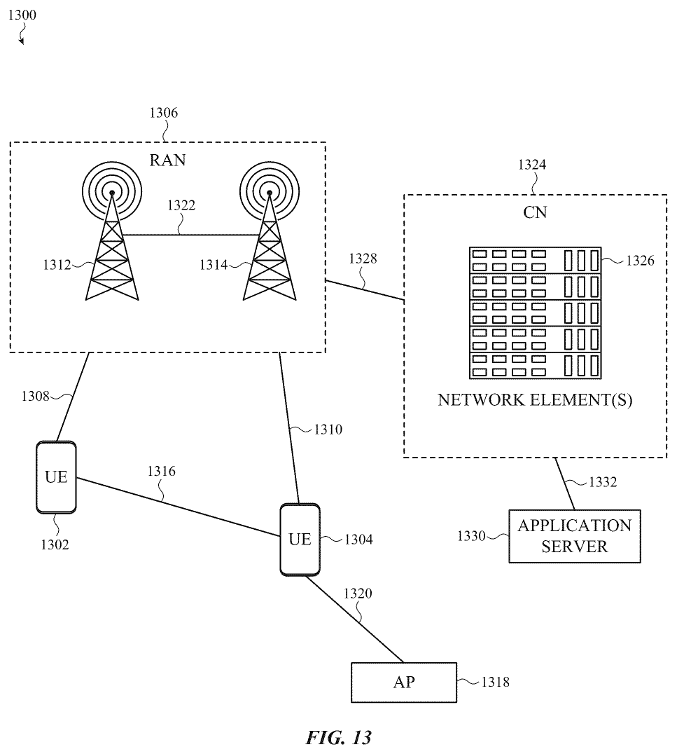

FIG. 13 illustrates an example architecture of a wireless communication system 1300, according to embodiments disclosed herein. The following description is provided for an example wireless communication system 1300 that operates in conjunction with the LTE system standards and/or 5G or NR system standards, and/or future standards for 6G, and so on, as provided by 3GPP technical specifications.

As shown by FIG. 13, the wireless communication system 1300 includes a UE 1302 and a UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations, such as base station 1312 and base station 1314, that enable the connection 1308 and connection 1310.

In this example, the connection 1308 and connection 1310 are air interfaces to enable such communicative coupling and may be consistent with one or more radio access technologies (RATs) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VOIP sessions, group communication sessions, etc.) for the UE 1302 and UE 1304 via the CN 1324. The application server 1330 may communicate with the CN 1324 through an IP communications interface 1332.

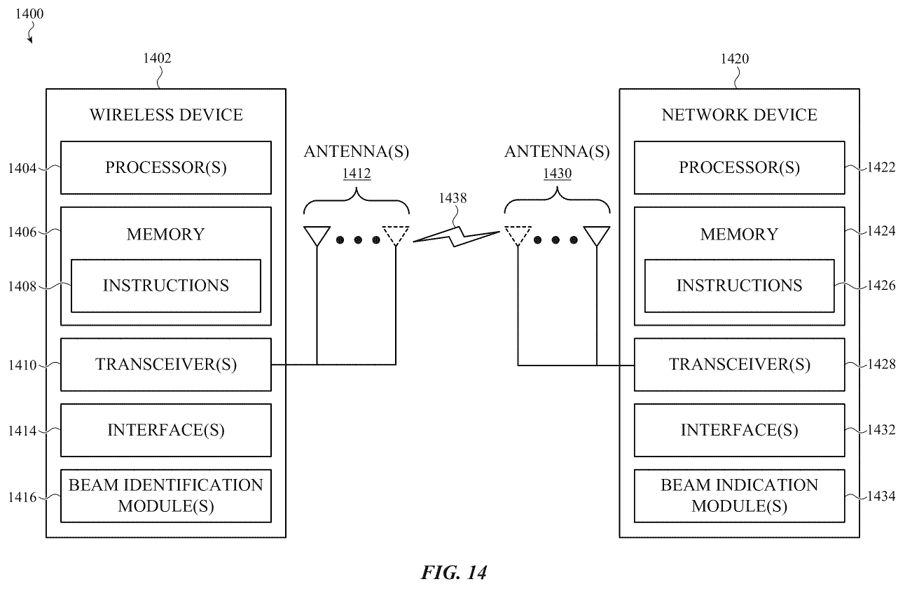

FIG. 14 illustrates a system 1400 for performing signaling 1438 between a wireless device 1402 and a network device 1420, according to embodiments disclosed herein. The system 1400 may be a portion of a wireless communication system as herein described. The wireless device 1402 may be, for example, a UE of a wireless communication system. The network device 1420 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1438) to and/or from the wireless device 1402 with other devices (e.g., the network device 1420) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a super-UE configuration module 1416. The super-UE configuration module 1416 may be implemented via hardware, software, or combinations thereof. For example, the super-UE configuration module 1416 may be implemented as a processor, circuit, and/or instructions 1408 stored in the memory 1406 and executed by the processor(s) 1404. In some examples, the super-UE configuration module 1416 may be integrated within the processor(s) 1404 and/or the transceiver(s) 1410. For example, the super-UE configuration module 1416 may be implemented by a combination of software components (e.g., executed by a DSP or a general processor) and hardware components (e.g., logic gates and circuitry) within the processor(s) 1404 or the transceiver(s) 1410.

The super-UE configuration module 1416 may be configured to, for example, receive, determine, and/or apply super-UE connection mode related message processing and/or perform related procedures.

The network device 1420 may include one or more processor(s) 1422. The processor(s) 1422 may execute instructions such that various operations of the network device 1420 are performed, as described herein. The processor(s) 1422 may include one or more baseband processors implemented using, for example, a CPU, a DSP, an ASIC, a controller, an FPGA device, another hardware device, a firmware device, or any combination thereof configured to perform the operations described herein.

The network device 1420 may include a memory 1424. The memory 1424 may be a non-transitory computer-readable storage medium that stores instructions 1426 (which may include, for example, the instructions being executed by the processor(s) 1422). The instructions 1426 may also be referred to as program code or a computer program. The memory 1424 may also store data used by, and results computed by, the processor(s) 1422.

The network device 1420 may include one or more transceiver(s) 1428 that may include RF transmitter and/or receiver circuitry that use the antenna(s) 1430 of the network device 1420 to facilitate signaling (e.g., the signaling 1438) to and/or from the network device 1420 with other devices (e.g., the wireless device 1402) according to corresponding RATs.

The network device 1420 may include one or more antenna(s) 1430 (e.g., one, two, four, or more). In embodiments having multiple antenna(s) 1430, the network device 1420 may perform MIMO, digital beamforming, analog beamforming, beam steering, etc., as has been described.

The network device 1420 may include one or more interface(s) 1432. The interface(s) 1432 may be used to provide input to or output from the network device 1420. For example, a network device 1420 that is a base station may include interface(s) 1432 made up of transmitters, receivers, and other circuitry (e.g., other than the transceiver(s) 1428/antenna(s) 1430 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1420 may include a super-UE configuration module 1434. The super-UE configuration module 1434 may be implemented via hardware, software, or combinations thereof. For example, the super-UE configuration module 1434 may be implemented as a processor, circuit, and/or instructions 1426 stored in the memory 1424 and executed by the processor(s) 1422. In some examples, the super-UE configuration module 1434 may be integrated within the processor(s) 1422 and/or the transceiver(s) 1428. For example, the super-UE configuration module 1434 may be implemented by a combination of software components (e.g., executed by a DSP or a general processor) and hardware components (e.g., logic gates and circuitry) within the processor(s) 1422 or the transceiver(s) 1428.

The super-UE configuration module 1434 may be configured to, for example, receive, determine, and/or apply super-UE connection mode related message processing and/or perform related procedures.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

What is claimed is:

1. A user equipment (UE), comprising:
a transceiver; and
a processor configured to,
establish a first radio resource control (RRC) connection with a base station via the transceiver;
associate with a secondary UE for collaboration of transmission of a data payload of one of the UE or the secondary UE to the base station; and
transmit a first portion of the data payload to the base station via the transceiver.

2. The UE of claim 1, wherein:
the processor is configured to associate with the secondary UE in response to:
a first message received at the UE from the base station, the first message associated with reconfiguration of the first RRC connection; or
a second message transmitted from the UE to the base station, the second message associated with UE assistance information (UAI).

3. The UE of claim 1, wherein the processor is configured to:
receive, from the base station and via the transceiver, a message requesting capability information related to the collaboration of the UE and the secondary UE for the transmission of the data payload to the base station; and
in response to the received message requesting the capability information related to the collaboration of the UE and the secondary UE, transmit, to the base station and via the transceiver, a message comprising,
an indication of capability of the UE related to the collaboration of the UE with the secondary UE for the transmission of the data payload;
a number of UEs being used for the transmission of the data payload to the base station;
capability information corresponding to a link between the UE and the secondary UE for transmission of signaling information between the UE and the secondary UE; and
capability information corresponding to a link between the UE and the base station and a link between the secondary UE and the base station.

4. The UE of claim 3, wherein:
the message transmitted to the base station, in response to the message requesting the capability information, further comprises:
bearer type information of data being transmitted to the base station supported by the UE and the secondary UE for the collaboration of transmission of the data payload,
wherein the capability information corresponding to the link between the UE and the secondary UE comprises a UE identification (ID) associated with the link between the UE and the secondary UE.

5. The UE of claim 4, wherein the message transmitted from the UE to the base station in response to the received message requesting the capability information is a message associated with a random-access channel (RACH) procedure, an initial access procedure, a non-access stratum (NAS) procedure, or an RRC configuration procedure.

6. The UE of claim 1, wherein the processor is configured to:
receive, from the base station, at least one message requesting,
establishment of a second RRC connection between the secondary UE and the base station; and
a release of the first RRC connection between the UE and the base station.

7. The UE of claim 1, wherein the processor is further configured to disassociate from the secondary UE for collaboration between the UE and the secondary UE for transmission of data between the UE and the base station using the UE and the secondary UE.

8. The UE of claim 1, wherein the processor is further configured to:
receive, from the base station, a message requesting UE capability information for the secondary UE; and
transmit, to the base station, a response message indicating the UE capability information for the secondary UE.

9. The UE of claim 1, wherein the UE and the secondary UE are associated with a single user or a single organization.

10. A method, comprising:
establishing a first radio resource control (RRC) connection between a first user equipment (UE) and a base station communicatively coupled with a core network;
based on configuration information received from the base station at the first UE, associating with a secondary UE for collaboration of transmission of data between the UE and the base station; and
transmitting, from the first UE, a first portion of the data to the base station and a second portion of the data that is different from the first portion of the data to the secondary UE for the transmission to the base station.

11. The method of claim 10, wherein associating with the secondary UE is in response to;
a first message received at the first UE from the base station, the first message associated with reconfiguration of the first RRC connection; or
a second message from the first UE to the base station, the second message associated with UE assistance information (UAI).

12. The method of claim 10, further comprising:
receiving, at the first UE from the base station, a message requesting capability information related to the collaboration of the first UE and the secondary UE for the transmission of the data between the first UE and the base station; and
in response to the received message requesting the capability information, transmitting, from the first UE to the base station, a message comprising an indication of capability of the first UE related to the collaboration of the first UE with the secondary UE for the transmission of the data, a number of UEs being used for the transmission of the data to the base station, the capability information corresponding to a link between the first UE and the secondary UE for transmission of signaling information between the first UE and the secondary UE, and capability information corresponding to a link between the UE and the base station and a link between the secondary UE and the base station.

13. The method of claim 12, further comprising:
transmitting, from the first UE to the base station, additional information comprising: bearer type information of data being transmitted to the base station using the first UE and the secondary UE, and the capability information corresponding to the link between the first UE and the secondary UE comprising a UE identification (ID) associated with the link between the first UE and the secondary UE, the additional information transmitted in the message sent from the first UE to the base station in response to the received message requesting the capability of the first UE.

14. The method of claim 12, wherein the message transmitted from the first UE to the base station in response to the received message requesting the capability information is a message associated with a random-access channel (RACH) procedure, an initial access procedure, a non-access stratum (NAS) procedure, or an RRC configuration procedure.

15. The method of claim 10, further comprising:
receiving, at the first UE from the base station, at least one message requesting establishment of a second RRC connection between the secondary UE and the base station and release of the first RRC connection between the first UE and the base station, and
sending, from the first UE to the secondary UE, a message requesting the establishment of the second RRC connection.

16. The method of claim 10, further comprising:
disassociating from the secondary UE for the transmission of the data between the first UE and the base station without using the secondary UE.

17. The method of claim 10, further comprising:
receiving, from the base station, a message requesting UE capability information for the secondary UE; and
transmitting, to the base station, a response message indicating the UE capability information for the secondary UE.

18. The method of claim 10, wherein the first UE and the secondary UE belong to a single user or different users.

19. A base station, comprising:
a memory configured to store instructions; and
a processor configured to execute the instructions stored in the memory, which, when executed, cause the base station to perform operations comprising:
establishing a first radio resource control (RRC) connection with a first UE;
transmitting, from the base station to the first UE over the first RRC connection, a message requesting to enable a mode for collaboration between the first UE and a secondary UE for transmission of data between the first UE and the base station using the first UE and the secondary UE;
transmitting, from the base station to the first UE over the first RRC connection, configuration information comprising information of a link between the first UE and the secondary UE for communication of signaling information with the secondary UE and the data for transmission to the base station via the secondary UE, and an identification of a group including the first UE and the secondary UE;
receiving, at the base station from the first UE, a first portion of the data for transmission between the first UE and the base station, and
receiving, at the base station from the secondary UE, a second portion of the data for transmission between the first UE and the base station using the secondary UE.

20. The base station of claim 19, wherein the base station is coupled with the first UE or the secondary UE using one or more of radio access technologies comprising 4G, 5G, 6G, Wi-Fi, and Bluetooth.
